(19) United States
(12) Patent Application Publication
(10) Pub. No.: US 2016/0278158 A1
(43) Pub. Date: Sep. 22, 2016

(54) METHODS FOR A LINK RECOVERY OF A WIRELESS NETWORK AND RESPECTIVE DEVICES

(71) Applicant: THOMSON LICENSING, Issy les Moulineaux (FR)

(72) Inventors: Koen VAN OOST, Borsbeek (BE); Karel VAN DOORSELAER, Edegem (BE); Roeland VAN DEN BROECK, Schilde (BE)

(73) Assignee: Thomson Licensing, Issy Les Moulineaux (FR)

(21) Appl. No.: 15/033,647

(22) PCT Filed: Oct. 29, 2014
(86) PCT No.: PCT/EP2014/073209

§ 371 Date: May 1, 2016

(30) Foreign Application Priority Data
Nov. 1, 2013 (EP) 13306505.2
Nov. 29, 2013 (EP) 13306634.0

(51) Int. Cl. H04W 76/02; H04W 12/04

(52) U.S. Cl. CPC H04W 76/028; H04W 12/04; H04W 84/12

(57) ABSTRACT

The method for a link recovery of a wireless network including an access point and a station, comprises the steps of: providing a reserve wireless network on the access point;installing a connection profile on the station for the reserve wireless network; after a connection loss in the wireless network,connecting the station to the access point via the reserve wireless network; the station requesting new security credentials from the access point via the reserve wireless network for a link recovery with the access point; the access point announcing new security credentials to the station via the reserve wireless network; and upon reception of the new credentials, the station reconfiguring its profile and triggering a link reconnect for the wireless network.

### TECHNICAL FIELD

The invention relates to the field of customer-premises equipment devices including a Wi-Fi node coupled to an IP network, e.g. via a digital subscriber line to a service provider.

### BACKGROUND OF THE INVENTION

Residential gateways are widely used to connect devices in the home to the Internet or any other wide area network (WAN). Residential gateways use in particular digital subscriber line (DSL) technology that enables a high data rate transmission over copper lines or optical lines. During the years, several DSL standards have been established differing in data rates and in range, for example ADSL and VDSL, which are referred to in this context as xDSL. Also optical transmission for Internet services is well known, for example fiber-to-the-home (FTTH) and fiber-to-the premises (FTTP). Residential gateways, but also other devices such as routers, WLAN (Wireless Local Area Network) forwarders, switches, telephones and set-top boxes, are understood in this context as customer premises equipment (CPE) devices.

Residential gateways including wireless technology have a key role in today's home and professional environments. A mechanism for connecting wireless devices to a local area network (LAN) is called Wi-Fi, which is a brand name of the Wi-Fi Alliance for devices using the IEEE 802.11 family of standards for wireless data transmission. The IEEE 802.11 standards define two types of wireless nodes, a general wireless device that can connect to other devices called a station (denoted as STA) and a special type of a STA that is in control of the network, namely an access point (denoted AP). A Wi-Fi network, also called WLAN, consists of an AP with one or several STA connected to the AP.

Together with the phenomenal success of Wi-Fi technology, more and more issues arise in the area of “whole home coverage”. As the transmission power and receiver sensitivity of a WLAN access point is limited, so is its service. The more and more Wi-Fi technology becomes actively used in multi-media applications the more the demand rises to have a whole home coverage. The most typical application in order to extend the service coverage of a WLAN access point is a WLAN repeater or “range extender”. Such a device connects to the main AP and repeats or extends the service area by allowing devices to connect to the WLAN repeater as if they were connecting to the main access point.

How to set up such a repeater network is known. Various mechanisms exist for that (e.g. WPS, manual connect), but what when the end user or gateway operator decides to change the security configuration? For example, an end user might think that the WLAN network of his home environment has been compromised, hence he acts upon it and changes the key passphrase. Also, a gateway operator might want to push a new encryption method, enforcing all of its customers to use the new encryption method (e.g. WPA/WPA2 changes to WPA2). Remote control of the AP is easy but what with the LAN devices? What if devices that have been previously switched on are re-enabled? Most of the service extending devices do not implement any form of user interface for low cost reasons. In all of the cases the end user must intervene by reconfiguring all endpoint (client) and repeater devices, which is a cumbersome and time consuming action.

When a WLAN network is being set up, all of the devices active in that network must be configured with the correct security credentials. The method used is irrelevant (WPS, manual, preconfigured), but it has to be done, one way or another. For security reasons it is common among access points not to display the security credentials which is not an issue until the end user needs to add another (non-WPS) device and has lost the credentials. At this time the only option is to change the credentials and re-enter them on all its devices, which can be a time consuming activity.

A different issue presents itself when the end user (or the gateway operator) wants to alter the security method used in the WLAN network. For instance, today WPA and WPA2 are common security methods, but in a year time the Wi-Fi Alliance (WFA) will prevent WPA-only being used on 802.11n/ac devices, so in order to benefit from the latest WLAN technology, an end user must make sure that all WPA-only devices have been replaced and that the gateway only uses WPA2 encryption. Once the method changes, it is impossible for any of the in-use devices to reconnect to the network without a manual (or WPS) reconfiguration. This can be time consuming and cumbersome given the fact that there are devices that don't implement WPS and have a poor user interface (e.g. Internet radios, surround sound receivers, etc.).

The current IEEE or WFA standards do not allow dynamic reconfiguration of the security credentials in an existing WLAN network. Once the configuration changes, all devices loose the link.

When a WLAN network is being set up, all of the devices active in that network must be configured with the correct security credentials. For security reasons it is common not to display the security credentials on the user interfaces (UI), which is not an issue until the end user needs to add another (non-WPS) device and forgot the credentials. In this case, the only option is to change the credentials and re-enter them on all its devices, a time consuming activity.

Another example of the same issue presents itself when the end user (or the gateway operator) wants to alter the security method used in the Home (W)LAN. To benefit from the latest WLAN technology, an end user must make sure that the security configuration of the Home (W)LAN matches the IEEE and WFA definitions for that new technology. Once the method changes it is impossible for any of the in-use devices to reconnect to the network without a manual or WPS reconfiguration. The current IEEE or WFA standards do not allow dynamic reconfiguration of the security credentials in an existing WLAN network. Once the configuration changes all devices lose the link.

### SUMMARY OF THE INVENTION

A method for a link recovery of a wireless network including an access point and a station, comprises the steps of: providing a reserve wireless network on the access point; installing a connection profile on the station for the reserve wireless network; after a connection loss in the wireless network, connecting the station to the access point via the reserve wireless network; the station requesting new security credentials from the access point via the reserve wireless network for a link recovery with the access point; the access point announcing new security credentials to the station via the reserve wireless network; and upon reception of the new credentials, the station reconfiguring its profile and triggering a link reconnect for the wireless network. The method provides in particular the reserve wireless network with a reserve service set identifier (SSID) to allow only a station of the wireless network to connect with the access point via the guest wireless network.

The wireless network is in a preferred embodiment a wireless network in accordance with an IEEE 802.11 standard and the reserve wireless network has the function of a backup wireless network and is for example a guest wireless network.

In an aspect of the invention, the method uses a security application, e.g. a secured publish/subscribe mechanism, for example a secured Data Distribution Service (DDS) application specified by the Object Management Group, as a communication interface in the wireless network, and/or a secure tunnel, e.g. VPN, IPsec . . . , prior to communication between the station and the access point via the reserve wireless network to inhibit intrusion of any unknown station into the wireless network. The wireless network is for example a home wireless network or an enterprise wireless network.

A customer premises equipment device comprises a microprocessor, a non-volatile memory and a first recovery application stored in the non-volatile memory, wherein the microprocessor is configured to perform the method by running the first recovery application.

A device comprises a microprocessor, a non-volatile memory and a second recovery application stored in the non-volatile memory, wherein the microprocessor is configured to perform the method by running the second recovery application.

The basic idea behind the invention is to leverage on the use of a recovery application software running on the access point and the station that will re-establish the wireless link after a reconfiguration has taken place, in combination with the existence of a reserve wireless network. The idea leverages on the fact that more and more in-home devices will start running applications that can be installed either at run time, e.g. through an app store, such as an Apple iOS appstore, Google play, etc., or are delivered pre-installed together with the WLAN device. The concept of the recovery is based on the fact that an application is installed on the access point and the station, ensuring that both devices know how to talk to each other. The idea however is not limited to a single access point and station.

### BRIEF DESCRIPTION OF THE DRAWINGS

Preferred embodiments of the invention are explained in more detail below by way of example with reference to schematic drawings, which show:

FIG. 1 a wireless network comprising an access point including a respective software stack and a station including a respective software stack,

FIG. 2 a prior art wireless network comprising a residential gateway and stations,

FIGS. 3-6 a wireless network being adapted for a link recovery between an access point and stations, and

FIG. 7 a message flow diagram illustrating a link recovery between an access point and a station.

### DETAILED DESCRIPTION OF PREFERRED EMBODIMENTS

In the following description, example methods for a recovery of a wireless network are described. For purposes of explanation, various specific details are set forth in order to provide a thorough understanding of preferred embodiments. It will be evident, however, to one skilled in the art that the present invention may be practiced without these specific details.

A customer premises equipment (CPE) device includes in a preferred embodiment a controller, e.g. a microprocessor, a non-volatile memory, in which an operating system is stored, a volatile memory for the operation of the CPE device, a Wi-Fi node for a wireless operation and a broadband connection, e.g. an xDSL connection. The Wi-Fi node includes a complex software driver, a physical layer with data buffers and an antenna. A CPE device of this kind is for example a residential gateway, which has a central position within a wireless local area network (WLAN).

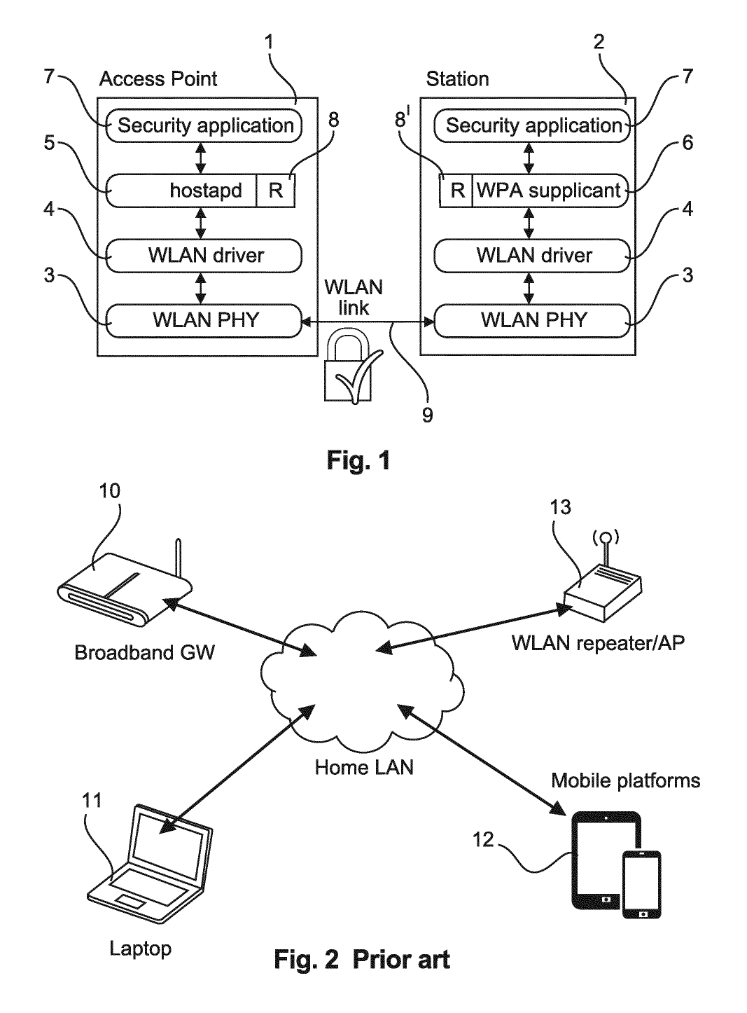

An example WLAN, comprising an access point (AP) 1 and a station (STA) 2, is schematically depicted in FIG. 1, and comprises the following essential software components:
a WLAN physical layer (PHY) 3 included in AP 1 and STA 2,
a WLAN driver 4 included in AP 1 and STA 2,
a WLAN management daemon: a host access point daemon (hostapd) 5 included in AP 1 and a Wi-Fi protected access (WPA) supplicant (WPA supplicant) 6 included in STA 2,
a security application 7 included in AP 1 and STA 2 provides encryption for the security of the WLAN link 9.

In a preferred embodiment, a recovery application 8 will interface with hostapd 5 and a recovery application 8′ will interface with WPA supplicant 6. These software modules 5, 6 are common, pseudo-standard modules in a WLAN software stack, allowing to be installed on any device platform irrespective of the chipset specific code. An application knows whether it is running on an access point or a station by pre-configuration or by detecting if either of the processes hostapd 5 or WPA supplicant 6 is running on the device, on which the application runs. The recovery application 8 interfacing with hostapd 5 and the recovery application 8′ interfacing with WPA supplicant 6 may be the same software modules or may be different software modules.

Upon installation on the access point 1, the recovery application 8 creates a reserve wireless network with a reserve service set identifier (SSID) on the access point 1, or in case it is already present, no action is undertaken. The reserve wireless network can be in particular a guest network or guest WLAN, or any wireless backup network. This is quite common given the fact that more and more users create a guest access on their access points in order to provide Internet connectivity without in-home LAN access to visitors, the family, guests, etc.. Guest wireless networks are known for example from Apple Airplay or an open source software OpenWRT. The reserve wireless network can be an open wireless network or a secured wireless network.

On the station 2, the recovery application 8′ will install a connection profile in WPA supplicant 6 for the GUEST SSID. Important is that the GUEST SSID must be placed as the last SSID in a connection profile list of the station 2. This has to be done because in case of a connection loss, the station 2 will check in a round robin way all profiles of the connection profile list for connectivity, and if the GUEST SSID is the first one, the station 2 will never reconnect to the wireless network.

The first recovery application 8 and the second recovery application 8′ provide therefore a solution for an automatic link recovery for a wireless network including an access point and one or several stations, after a security change of the wireless network has occurred. The solution leverages advantageously on a secure reserve wireless network access mechanism, e.g. a secure guest wireless network. The recovery application 8 installs a reserve wireless network including an identifier, for example a BSSID (Basic Service Set Identification) or a SSID, on the access point, the identifier identifying the reserve wireless network, while on the station a connection profile to this reserve wireless network is installed by the recovery application 8′.

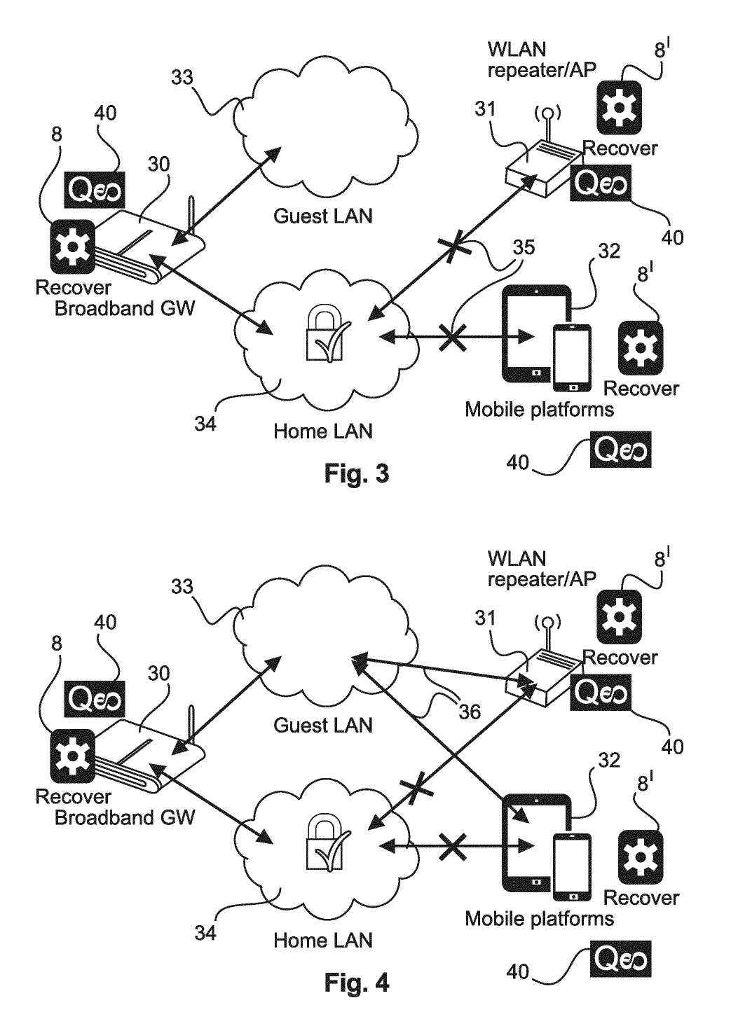

An exemplary embodiment of a prior art wireless network comprising a residential gateway 10 having the function of an access point, and stations: a home computer 11, a smart phone or a tablet computer 12 and a WLAN repeater 13 is shown in FIG. 2.

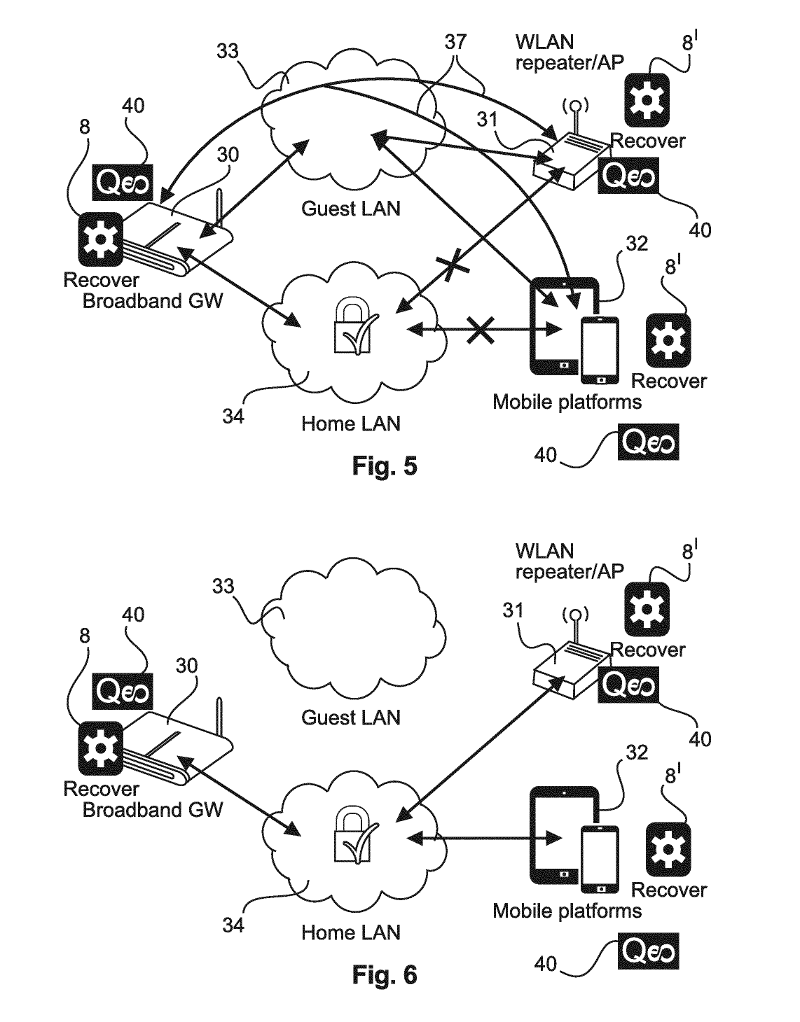

The FIGS. 3-6 illustrate a solution using the recovery applications 8, 8′ for a wireless network 34, e.g. in-home wireless network, comprising a residential gateway 30 and stations: wireless client devices 31, 32. The solution uses advantageously in addition a secured publish/subscribe mechanism 40, for providing a secure reserve wireless network for a recovery of the wireless link between the residential gateway 30 and the client devices 31, 32.

The recovery method leverages therefore in this embodiment in particular on a secure “GUEST” access mechanism, by using a guest wireless network 33. The recovery application 8 installs an open security guest BSSID on the access point, the residential gateway 30 shown in FIG. 3, while on the stations, the client devices 41 and 42, a connection profile to this guest wireless network is installed. The recovery method creates therefore a “walled garden” configuration approach as the connectivity will be resumed upon connection loss but only to a network with limited access. The security is guaranteed over an open WLAN network by using the secure publish/describe mechanism 40. Only devices registered to the in-home wireless network 34 are allowed to reconnect and all communication between the devices 30-32 is encrypted on Internet Protocol (IP) level.

Upon a connection loss 35, FIG. 3, the client devices 31, 32 consult their data base of known networks, one of them being the guest wireless network 33 with the defined GUEST SSID. Based on the existence of the connection profile for the GUEST SSID, the client devices 31, 32 will automatically connect to this network 33, indicated by arrows 36, for enabling the recovery applications 8, 8′ to re-establish the in-home wireless network 34, FIG. 4.

Once a connection has been established via the guest wireless network 33, the recovery applications 8, 8′ on the client devices 31, 32 and the residential gateway 30 open a secure connection via the publish/describe mechanism 40, indicated by arrows 37, and request a new set of security credentials for the in-home wireless network 34, FIG. 5. After retrieving the correct security credentials from the residential gateway 30, the recovery applications 8, 8′ disconnect from the guest wireless network 33 and reconnect to the in-home wireless network 34, FIG. 6.

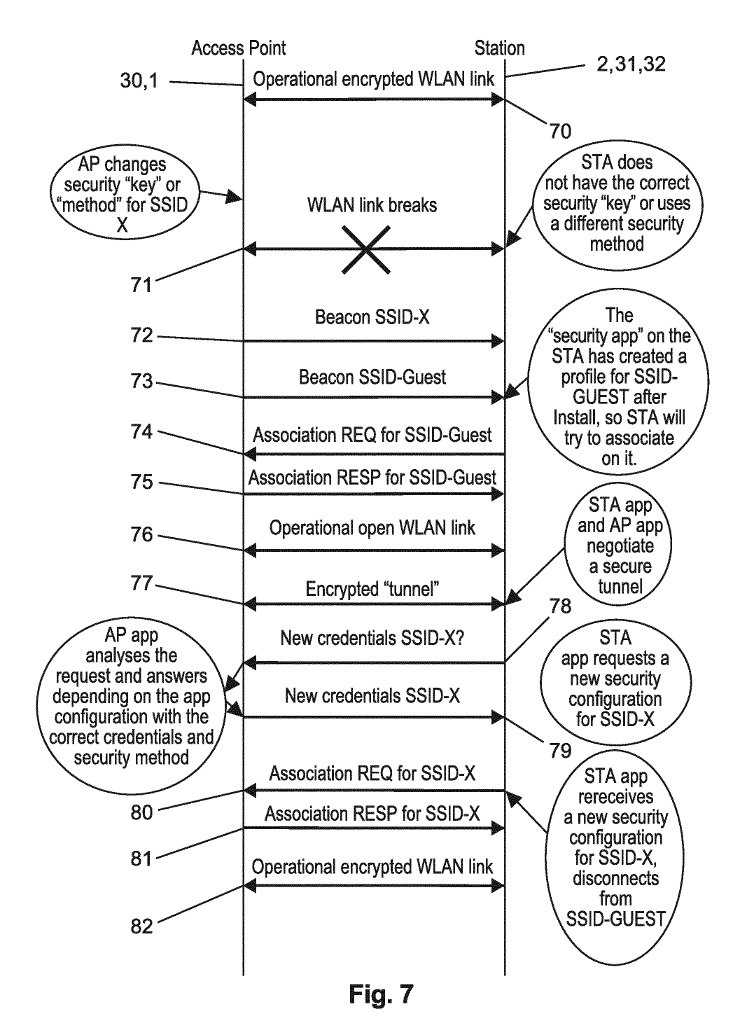

The recovery method is described in more detail below in a sequence diagram depicted in FIG. 7. This figure illustrates the various interactions of the recovery applications 8, 8′.

Upon installation on the access point 1, the recovery application 8 of the access point 1 creates a GUEST SSID on the access point 1 with “open security”, or in case the guest wireless network is already present, no action is to undertaken. On the station 2, the recovery application 8′ of the station 2 will install a connection profile in WPA supplicant 6 for the GUEST SSID.

Upon a connection loss of an operating wireless link 70 between the access point 1 and the station 2, step 71, the station 2 will re-connect to the access point 1 via the open guest network. After the connection loss, the station 1 continues to send beacon signals for the in-home wireless network 34 as well as beacon signals for the guest wireless network 33, steps 72, 73. The station 2 will send a respective connection request: “Association REQ” for the SSID-GUEST, step 74, and the access point 1 will respond to this request by:

“Association RESP” for the SSID-GUEST, step 75, in case of correct credentials for the guest wireless network 33. The guest wireless network 33 is then operational, step 76.

Both recovery applications 8, 8′ will then arrange a secure tunnel prior to communication, e.g. via VPN, IPsec, etc., or for example by using a secured publish/subscribe mechanism, as a communication interface, for the communication via the guest wireless network 33, step 77. For the concept of the invention, the security aspect is less relevant but for the overall success of the application it is advantageous to implement a secure communication channel, e.g. a secure tunnel, step 77, as otherwise the guest wireless network 33 will be vulnerable to an attack during the recovery period: In order to prevent a “man in the middle” attack, a secure connection between both recovery applications 8, 8′ should be mandatory.

The station recovery application 8′ will then request new security credentials from the access point recovery application 8 to connect to the access point 1 via the in-home wireless network 34, step 78. Doing so, the station recovery application 8′ mentions a DEVICE ID and a SSID/BSSID for which the credentials are targeted. Should the station 2 have associated to a GUEST SSID of another access point, e.g. a residential gateway of a neighbor, then the access point recovery application 8 must issue a disconnect of that station upon detection that there is an incoming request for an unknown BSSID. If the client is disconnected, a state that can be propagated to the access point recovery application 8 via the WPA supplicant 6, the access point recovery application 8 will blacklist that BSSID for at least 24 hours and take another BSSID with an SSID equal to “GUEST”.

If the access point recovery application 8 receives a request for security credentials matching its SSID/BSSID, then it will reply (publish) by announcing the new security credentials: security method+passphrase, via the guest wireless network 33, step 79. At this point further a “second stage authentication” can be created. The access point 1 can push the decision to publish the security credentials to the end user or operator, allowing him to reconfirm that a specific device can be added to the in-home wireless network 34 again, or the access point recovery application 8 can consult a predefined policy, e.g. specific device IDs are allowed, and others require manual confirmation. The station recovery application 8′ will wait then for an answer from the access point 1.

Upon reception of the new credentials, step 79, the station recovery application 8′ will reconfigure the profile in the WPA supplicant 6 and trigger a link reconnect for the home wireless network 34 by sending an association request for SSID-X to the access point 1, step 80. The access point 1 will respond to the request by a message: “Association RESP” for the SSID-X, step 81, in case of correct credentials for the in-home wireless network 34, and the in-home wireless network 34 is then again operational, step 82.

The invention has the following advantages: No user interaction is needed to reconfigure the WLAN network. A second stage authentication can be applied. Further, the reconfiguration remains secure by using a security application, even though the guest network 33 remains open.

Also other embodiments of the invention may be utilized by one skilled in the art without departing from the scope of the present invention. The method as described may be used in particular for all kinds of CPE devices using Wi-Fi. The invention resides therefore in the claims herein after appended.

1. Method for a link recovery of a wireless network including an access pointand a station, comprising
providing a reserve wireless network on the access point,
installing a connection profile on the station for the reserve wireless network,
after a connection loss in the wireless network, connecting the station to the access point via the reserve wireless network,
the station requesting new security credentials from the access point (1, 30) via the reserve wireless network for a link recovery with the access point,
the access point announcing new security credentials to the station via the reserve wireless network, and
upon reception of the new credentials, the station reconfiguring its profile and triggering a link reconnect for the wireless network.

2. The method of claim 1, comprising providing the reserve wireless network with a reserve service set identifier (SSID) to allow only a station of the wireless network to connect with the access point via the reserve wireless network.

3. The method of claim 1, comprising the station requesting the new security credentials from the access point by including in the request an identifier of the station and/or an identifier DEVICE ID of the access point.

4. The method of claim 1, wherein the wireless network is a wireless network in accordance with an IEEE 802.11 standard and the access point includes a host access point daemon (hoctapd) software application and the station includes a Wi-Fi protected access (WPA) supplicant software application.

5. The method of claim 4, comprising upon reception of the new credentials, the station reconfiguring the profile in the WPA supplicant and triggering a link reconnect with the access point.

6. The method of claim 1, comprising using a secured publish/subscribe mechanism, as a communication interface in the wireless network, and/or using a secure tunnel, prior to communication between the station and the access point via the reserve wireless network.

7. The method of claim 1, wherein the wireless network is a home wireless network or an enterprise wireless network.

8. The method of claim 1, wherein the access point registers for the reserve wireless network, which stations are included in the the wireless network to inhibit a connection of a station not being part of the wireless network with the reserve wireless network.

9. The method of claim 1, wherein the reserve wireless network has the function of a backup wireless network and is for example a guest wireless network.

10. Customer premises equipment device comprising a microprocessor, a non-volatile memory and a recovery application (8) stored in the non-volatile memory, wherein the microprocessor is configured to perform a method according to claim 1.

11. The customer premises equipment device of claim 10, wherein the customer premises equipment device is a residential gateway, an enterprise gateway, a router, switch, set-top box or any other Wi-Fi customer premises equipment device acting as an access point.

12. Customer premises equipment device comprising a microprocessor, a non-volatile memory and a recovery application stored in the non-volatile memory, wherein the microprocessor is configured to perform a method according to claim 1.

13. The customer premises equipment device of claim 12, wherein the device is a WLAN repeater, a smart phone, a tablet PC or a laptop acting as a station.

14. Method for a link recovery of a wireless network including an access point and a station, wherein a reserve wireless network is provided on the access point and a connection profile is installed on the station for the reserve wireless network, comprising
after a connection loss in the wireless network, connecting the station to the access point via the reserve wireless network,
the station requesting new security credentials from the access point via the reserve wireless network for a link recovery with the access point,
the access point is configured to announce new security credentials to the station via the reserve wireless network, and
upon reception of the new credentials, the station reconfigures its profile and triggers a link reconnect for the wireless network.

15. The method of claim 14, comprising providing the reserve wireless network with a reserve service set identifier (SSID) to allow only a station of the wireless network to connect with the access point via the reserve wireless network.

16. The method of claim 14, comprising the station requesting the new security credentials from the access point by including in the request an identifier of the station and/or an identifier DEVICE ID of the access point.

17. The method of claim 14, wherein the wireless network is a wireless network in accordance with an IEEE 802.11 standard and the station includes a WPA supplicant software application.

18. The method of claim 17, comprising upon reception of the new credentials, the station reconfiguring the profile in the WPA supplicant and triggering a link reconnect with the access point.

19. Method for a link recovery of a wireless network including an access point and a station, wherein a reserve wireless network is provided on the access point and a connection profile is installed on the station for the reserve wireless network, comprising
after a connection loss in the wireless network, connecting the access point with the station via the reserve wireless network,
the access point providing new security credentials to the station via the reserve wireless network for a link recovery with the access point,
the access point announcing new security credentials to the station via the reserve wireless network, and
upon reception of the new credentials, the station is configured to reconfigure its profile and trigger a link reconnect for the wireless network.

20. The method of claim 19, comprising providing the reserve wireless network with a reserve service set identifier (SSID) to allow only a station of the wireless network to connect with the access point via the reserve wireless network.

21-22. (canceled)
